(19) United States
(12) Patent Application Publication
(10) Pub. No.: US 2006/0006019 A1
(43) Pub. Date: Jan. 12, 2006

(54) Expandable steering system

(76) Inventors: Anthony Louis Caserta, Huntington, NY (US); Charles William Caserta, Huntington, NY (US)

Correspondence Address: WILLIAM COLLARD;COLLARD & ROE, P.C., 1077 NORTHERN BOULEVARD, ROSLYN, NY, 11576, US

(21) Appl. No.: 11/177,952

(22) Filed: Jul. 7, 2005

Related U.S. Application Data
(60) Provisional application No. 60/586,270, filed on Jul. 8, 2004.

(51) Int. Cl. B62D 5/04

(52) U.S. Cl. 180/443

(57) ABSTRACT

An expandable steering system for an amphibious vehicle whose wheels move into retracted and deployed positions comprises a steering column connected to a steering wheel, a rack and pinion or recirculating ball mechanism connected to the column for moving the system, and a series of expandable shafts connected through gearboxes to the wheels. The shafts expand and contract as the wheels move through their retracted and deployed positions, and the angle at which the steering mechanism is connected to the wheels does not change as the wheels move.

### CROSS REFERENCE TO RELATED APPLICATIONS

This application claims priority under 35 USC 119(e) from U.S. Provisional Application No. 60/586,270, filed on Jul. 8, 2004, the disclosure of which is herein incorporated by reference.

### BACKGROUND OF THE INVENTION

1. Field of the Invention

The invention relates to an expandable steering system for vehicles having wheels that move into different positions. In particular, the invention relates to a steering system that has shafts whose length is adjustable to accommodate the movement of the vehicle's wheels to different lateral positions and elevations relative to the main body of the vehicle.

2. The Prior Art

Amphibious vehicles are used in places where it is necessary to travel both on land and water in one trip. Such vehicles convert easily from a land-based vehicle into a water-based vehicle by adjusting the apparatuses that drive the vehicles on land and in water. For example, in U.S. Pat. No. 5,727,494, the disclosure of which is incorporated herein by reference, the wheels of the vehicle, which allow it to be driven on land, are raised above the water line once the vehicle enters the water, Pontoons, which are disposed on the bottom of the vehicle, are then used to keep the vehicle buoyant.

The front wheels of most amphibious vehicles to date are independent of the float means and are a fixed distance apart or use complex computer protocols to maintain position, such as in U.S. Pat. Nos. 5,570,653 and 5,531,179. They mostly meet the Bosch automotive design criteria which includes the following general design requirements:
1. Jolts from irregularities in the road surface must be damped as much as possible in being transmitted back to the steering wheel. However, such damping must not cause the driver to lose contact with the road.
2. The basic design of the steering kinematics must satisfy the Ackermann conditions: the extension of the wheel axes of the left and right front wheels, when at an angle intersect on an extension of the rear axle.
3. The steering by means of suitable stiffness must react to minute steering corrections
4. When the steering wheel is released, the wheels must return to the straight-forward position and must remain stable in this position.
5. The steering system should have as low a ratio as possible (number of steering-wheel turns from lock to lock)
6. The steering should be accomplishable with a reasonable operational force to be exerted by the driver. (Often include a power boost element to make steering easier for the operator)

In addition, the amphibious systems generally have a seventh general requirement of enabling operations of the same vehicle on the waterways. This seventh requirement is usually achieved with either a dual steering system (One on land and a second for use on the water) or a compound steering system that enables the amphibian to maintain amphibious operations on both the land (using front steering wheels), and on the water (using either steerable water jets or propellers, or steering rudders.)

As an example, the system used in U.S. Pat. No. 5,727,494 uses a fixed width front wheel axle and associated fixed width steering system which meets the Bosch design requirements for land travel and is connected to a rudder for at sea operations. In this design, the fixed width front wheel assembly must retract up into the cab area and this in turn limits cab space, increases the height of the center of gravity of the vehicle and requires a relatively heavy retraction system.

Moreover, it is clear that the optimum amphibious vehicle, with its pontoons, catamaran hulls or other float means, should have a variable width beam. The vehicle beam must be narrow on land to meet the DOT Highway width restrictions (7 to 8.5 feet maximum width as an example on large 20 to 50 passenger vehicles—4 to 7 feet on the small 2 to 4 passenger versions); and must have a wide beam on the water (13 to 15 feet as an example on the large vehicles and 8 to 10 feet on the small versions) to achieve marine (Ocean Going or Lake or Sound or Bay or other water bodies) stability and also performance enhancements requirements.

A significant savings in weight and a lower vehicle center of gravity is made possible when the vehicle is traveling on the waterways, if the wheels could retract into the pontoons instead of into the cab body. This is prevented by the fixed axle design and the associated fixed width steering design. If the front wheels could be individually placed within each pontoon, the retraction would be far simpler and lighter. At the present time, the state of the art of the fixed width steering system to date has prevented the separation of individual front wheels.

The current steering system impacts the overall performance of these vehicles. The current amphibious vehicles described above and marketed under the name “Pontiphian”, are equipped with steering means coupled to the front wheels (and/or rear wheels); and also simultaneously to the propeller angle drive (or rudder) for steering the vehicle both on land and through water.

Without a steering system which enables the pontoons and the associated wheels to expand, the steering axle must be attached to the portion of the vehicle which cannot expand. It would be desirable to have a system which enables individual wheel mounting, individual wheel drive operations, and Ackermann compatible steering operations with the pontoons in both the expanded (at sea) configuration and with the pontoons in the inboard position (on land).

With the previous amphibious steering system designs which do not allow for the expansion of the front wheel set, the steering axle must be attached to the portion of the vehicle which cannot expand. This in turn causes a penalty in weight, complexity and operational efficiency. The retraction system in turn also becomes much heavier and the wheels require substantial storage space in the cockpit or cab area.

Finally, care must be taken to insure that the system does not have excessive play and still meets CFR 49 DOT Steering Requirements.

### SUMMARY OF THE INVENTION

It is therefore an object of the invention to provide a steering system that can allow for the expansion and retraction of the front wheels.

To optimize the amphibious designs, the challenge is to have a common power assisted steering system which allows the steering to operate on both land and water, to operate with the float means in either the inboard or outboard position without a major impact on associated retraction system design, and without a major impact on the availability of space in the cab or cockpit area. Furthermore, the Federal Highway Transportation Safety Administration (FHTSA) requires a mechanical steering connection at all times. Thus, all electric or all hydraulic systems cannot be used unless they have a parallel backup mechanical steering linkage.

This object is accomplished by a steering system which enjoys the benefits and capabilities of the existing amphibious steering systems including: 1) satisfaction of Ackermann conditions, 2) driver feedback sensitivity, 3) driver control force requirements, and 4) minute steering control; plus enables a) the wheels to be independently mounted; b) steered when the pontoons in which the wheels are mounted are expanded apart; c) retains the steering tolerances when the wheels are retractable; and d) enables the retention of a low center of gravity.

The steering system according to the invention uses a conventional steering system, which is either a Rack and Pinion Type Steering System or a Recirculating Ball Steering System, with the addition of elements which enable the spreading of the pontoons and retraction of the wheels to a lower position thereby providing a lower center of gravity and retaining the feedback characteristics needed by the operator and the controllability design tolerances.

The system comprises a steering column connected to a steering wheel, a rack and pinion or adjustable ball mechanism connected to the column for moving the system, and a series of expandable shafts connected through gearboxes to the wheels. The shafts expand and contract as the wheels move through their retracted and deployed positions, and the angle at which the steering mechanism is connected to the wheels does not change as the wheels move.

In a preferred embodiment, there is an expandable arm which rotates bi-directionally in response to steering motions of the steering wheel, and which is connected to the rack and pinion mechanism. A right angle gearbox is connected to the end of the arm and another expandable shaft is connected via CV joint to another gearbox. A gearbox arm extends from the second gearbox, which is connected to another adjustable shaft and then to a ball joint, a steering arm, and finally the wheel hub. As the wheels move laterally when the pontoons expand and vertically when the wheels retract, the shafts expand and contract to keep the steering system at a constant angle to the wheels. In a preferred embodiment, the first expandable arm has a telescoping shaft, with the inner shaft configured in a triangular or star-shaped cross-section. The inner shaft slides within the outer shaft along ball bearings disposed in the indented portions of the star-shaped shaft. This allows a smooth expansion and retraction of the shaft while minimizing play between the two shafts. In an alternative embodiment, the shafts are slidably held together by a toothed mechanism, with teeth on one of the shafts and corresponding indents on the other.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a front view of the system according to the invention;

FIG. 2 shows a plan view of the system according to the invention; and

FIG. 3 shows a cross-sectional view of a preferred embodiment of a shaft for use in the steering system according to the invention.

### DETAILED DESCRIPTION OF THE PREFERRED EMBODIMENT

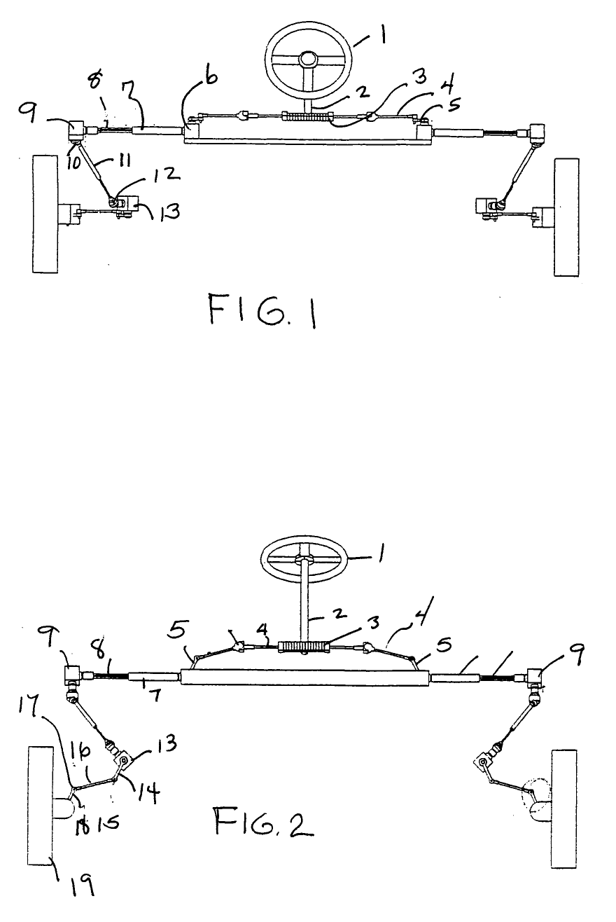

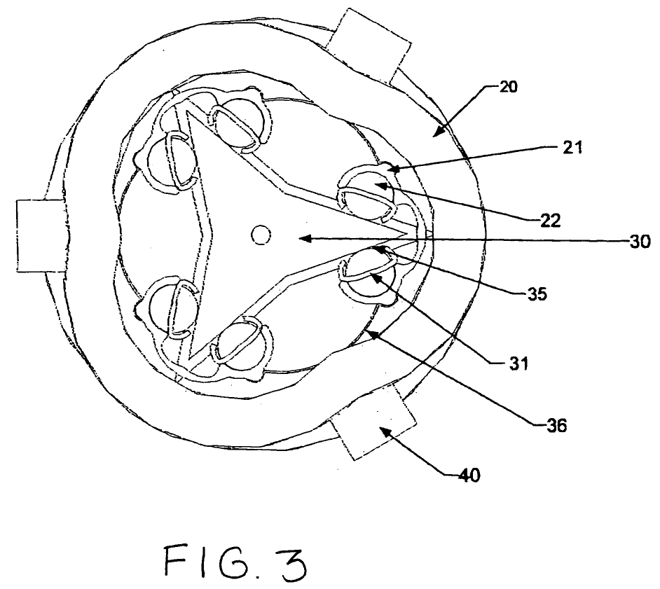

Referring now in detail to the drawings and, in particular, FIGS. 1 and 2 show one embodiment of the system according to the invention, which comprises a steering wheel 1 connected to a fixed or adjustable steering column 2. Column 2 is connected to rack and pinion 3. Rack and pinion 3 is connected to an extendable Ackerman or Pitman arm 4, which is connected to a gearbox arm 5. Gearbox arm 5 is connected to a right angle gearbox 6, which is connected to a splined or keyed hollow steering shaft 7, which cooperates with an inner splined or keyed shaft 8. Shaft 8 is connected to another right angle gearbox 9, which is connected to a plunge-type CV (constant velocity) joint 10. CV joint 10 is connected to an extendable shaft 11, which is connected to another CV joint 12. CV joint 12 is connected to a power boost gearbox or torquemotor 13, which is connected to another gearbox arm 14. Gearbox arm 14 is connected to a ball joint 15, which is connected to an adjustable length drag link 16. Drag link 16 is connected to another ball joint 17, which is connected to a steering arm 18. Finally, steering arm 18 is connected to a wheel hub 19. The same arrangement exists for both front wheels of the vehicle.

In operation, turning steering wheel 1 rotates column 2 and its attached pinion, which moves rack 3 either to the left or right. This movement of rack and pinion 3 causes arms 4 and 5 to move and turn the gears in right angle gearbox 6. This motion then drives shafts 7 and 8, which then moves right angle gearbox 9. Right angle gearbox 9, in use, can be connected to pontoons of an amphibious vehicle and can move with the pontoons as they expand and contract.

The steering signal from the steering wheel 1 then passes through CV joint 10, shaft 11 and CV joint 12. CV joint 12 allows the wheels of the amphibious vehicle to retract into the pontoons. CV joint 12 then transmits the steering signal through the power boost gearbox or torquemotor 13, which amplifies the steering signal to provide the actual steering power of the vehicle. The output from this is then transmitted through joints and arms 14-19 to wheel hub 19, to turn the wheels of the vehicle.

In a preferred embodiment, the extendable steering shaft is formed from an outer shaft 20 having races 21 for holding ball bearings 22. An inner shaft 30, having an outer race 35, contacts ball bearings 22. Ball bearings 22 are held in place by a retainer 31, which allows bearings 22 to rotate without falling out of the shafts. Plugs 40 are inserted into an aperture in outer shaft 20, and press against connecting pieces 36, to eliminate play between the outer and inner shafts. Inner shaft 30 can then slidably move within outer shaft 20 with little or no play, and a smooth motion.

Accordingly, while only a few embodiments of the present invention have been shown and described, it is obvious that many changes and modifications may be made thereunto without departing from the spirit and scope of the invention.

What is claimed is:

1. A steering system for use in vehicles, comprising:
a device for translating rotational motion into angular motion,
a rotationally-driven steering device connected to the translating device,
a plurality of shafts rotatably or pivotably connected to each other, a first of said shaft connected to said translating device;
at least one wheel connected to an end of one of said shafts, wherein turning the steering device moves the shafts to turn the at least one wheel, and wherein at least one of said shafts is extendable and retractable to correspond to linear motion of the wheels.

2. The steering system according to claim 1, wherein the device for translating rotational motion into translational motion is selected from the group consisting of a rack and pinion and a recirculating ball.

3. The steering system according to claim 1, wherein the steering device is a wheel connected to a steering column.

4. The steering system according to claim 1, wherein a plurality of said shafts are extendable and retractable to compensate for vertical and horizontal movement of the at least one wheel.

5. The steering system according to claim 1, wherein the at least one extendable and retractable shaft comprises: an outer shaft having an inner wall, and an inner shaft slidably disposed within said outer shaft, said outer shaft having an inner surface, the inner surface of said outer shaft having at least one race; and a plurality of ball bearings disposed in the at least one race for allowing the inner shaft to slide within the outer shaft without play.

6. A steering system comprising:
a steering wheel;
a steering column connected to the steering wheel;
a pinion connected to the steering column, said pinion cooperating with a corresponding rack;
at least one Ackerman or Pitman arm connected to the rack;
a gearbox arm connected to the Ackerman or Pitman arm;
a right angle gearbox connected to the gearbox arm;
an expandable and retractable shaft connected at one end to the gearbox;
a right angle gearbox connected to another end of the expandable and retractable shaft;
a plunge type CV joint connected to the right angle gearbox;
a second expandable and retractable shaft connected at one end to the CV joint;
another CV joint connected to another end of the second shaft;
a power boost gearbox or torquemotor connected to said another CV joint;
a second gearbox arm connected to the power boost gearbox or torquemotor;
a ball joint connected to the second gearbox arm;
an adjustable length drag link connected at one end to the ball joint;
a second ball joint connected to another end of the drag link;
a steering arm connected to the second ball joint; and
a wheel hub connected to the steering arm,
wherein the shafts expand and retract to compensate for lateral and vertical movement of the wheel hub.
